(19) United States
(12) Patent Application Publication
(10) Pub. No.: US 2016/0139721 A1
(43) Pub. Date: May 19, 2016

(54) RECORDABLE PHOTO FRAME WITH USER-DEFINABLE TOUCH ZONES

(71) Applicant: HALLMARK CARDS, INCORPORATED, Kansas City, MO (US)

(72) Inventors: TYLER JAMES RICHMOND, ROELAND PARK, KS (US); CHRISTOPHER JAMES SHIELDS, KANSAS CITY, MO (US); NICHOLAS PEDERSEN, LAWRENCE, KS (US); DANIELLE M. CALDWELL, KANSAS CITY, MO (US)

(21) Appl. No.: 14/541,840

(22) Filed: Nov. 14, 2014

(51) Int. Cl. G06F 3/041; G06F 3/16; G06F 3/0484; G06F 3/044; G06F 3/0488

(52) U.S. Cl. CPC G06F 3/0416; G06F 3/0412; G06F 3/044; G06F 3/04883; G06F 3/04847; G06F 3/165; G06F 3/167; G06F 2203/04808; G06F 2206/20

(57) ABSTRACT

Methods and devices for storing and associating audio tracks to user-defined touch zones on a photo frame are provided. In one aspect, the photo frame includes a capacitive sensor array that provides a platform for a user to overlie a photo thereon. The capacitive sensor is coupled to a microprocessor that permits the generation of user-defined touch zones based on the user selecting an object in the photo by encircling the object with a touch gesture. The frame also includes a microphone for recording an audio track corresponding to each user-defined touch zone. The audio tracks and corresponding touch zones are stored in a memory. In some embodiments, the microprocessor can determine a selected touch zone based on a location of the user's touch and, based on the location, playback the audio track corresponding to the selected touch zone.

### BACKGROUND

Photo frames are traditionally provided as a means for securing and displaying memories in the form of photos. Photos are often gifted to friends and family in photo frames to serve as mementos of particular events or relationships. A user can generally look at a photo in a frame and reminisce about particular events or relationships. Oftentimes, however, memories can fade, and individual perspectives of a particular event or relationship may differ. Accordingly, there is a need for a photo frame that allows one or more users to capture their own audible comments or perspectives on the photo. Additionally, because photos are interchangeable, there is also a need for a photo frame that associates the audible comments with user-definable portions of the photo.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed description section below. This summary is not intended to identify key features or essential features of the claimed subject matter, nor is it intended to be used as an aid in isolation to determine the scope of the claimed subject matter.

In brief and at a high level, this disclosure describes, among other things, a photo frame and method for storing audio tracks and associating them with user-defined touch zones on a photo supported by the frame. The photo frame includes a capacitive sensor array that provides a backing for a user to place a photo thereon. The capacitive sensor is coupled to a microprocessor that enables the creation of user-defined touch zones by allowing the user to encircle an area of the photo with a touch gesture. The frame also includes a microphone for permitting recording of an audio track corresponding to each user-defined touch zone. The audio tracks and corresponding touch zones are stored in a memory. In some embodiments, the microprocessor can determine a selected touch zone based on a location of the user's touch and, based on the location, playback the audio track corresponding to the selected touch zone.

This summary is provided to introduce a selection of concepts in a simplified form. These concepts are further described below in the detailed description of the preferred embodiments. Various other aspects and advantages of the present invention will be apparent from the following detailed description of the preferred embodiments and the accompanying drawing figures.

### DESCRIPTION OF THE DRAWINGS

Illustrative embodiments of the invention are described in detail below with reference to the attached drawing figures, and wherein:

FIG. 1 is a front elevation view of a photo frame assembly for storing and associating audio tracks to user-defined touch zones, in accordance with aspects of the disclosure;

FIG. 2 is an exploded front perspective view of the photo frame assembly of FIG. 1, particularly illustrating a capacitive sensor array and its positioning with respect to an exemplary photo, in accordance with an aspect of the disclosure;

FIG. 3 is a rear perspective view of the photo frame assembly of FIG. 1 with a portion cut away for clarity, particularly illustrating an enclosure, chassis, and frame assembly components in accordance with an aspect of the disclosure;

FIG. 4 is a front elevation view of the photo frame assembly for operation, particularly illustrating the positioning of the capacitive sensors with respect to an exemplary picture, in accordance with an aspect of the disclosure;

FIG. 5 is a front elevation view of a first touch gesture encircling a first object on the exemplary picture, in accordance with an aspect of the disclosure;

FIG. 6 is a front elevation view of the first touch gesture having encircled the first object on the exemplary picture and creating a first user-defined touch zone, in accordance with an aspect of the disclosure;

FIG. 7 is a front elevation view of a second touch gesture having encircled a second object on the exemplary picture and creating a second user-defined touch zone, in accordance with an aspect of the disclosure;

FIG. 8 is a front elevation view of a third touch gesture having encircled a third object on the exemplary picture and creating a third user-defined touch zone, in accordance with an aspect of the disclosure; and

FIG. 9 is a front elevation view of an alternate embodiment of a photo frame assembly for storing and associating audio tracks, in accordance with aspects of the disclosure.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION

The subject matter of select embodiments of the invention is described with specificity herein to meet statutory requirements. But, the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

Methods and devices are described herein for recording, storing and associating audio tracks with user-defined touch zones corresponding to areas of a photo supported on a frame. In particular, one aspect of the invention is directed to a photo frame. The photo frame includes a capacitive sensor array including a set of capacitive sensors, wherein each capacitive sensor in the set is operable to detect touch inputs; a memory operable for storing one or more user-defined touch zones, wherein each user-defined touch zone corresponds to a unique subset of capacitive sensors in the set; a microprocessor coupled to the capacitive sensor array and the memory, wherein the microprocessor is configured to generate each of the one or more user-defined touch zones by detecting a plurality of touch inputs encircling a unique subset of capacitive sensors; and a microphone coupled to the microprocessor and operable to record an audio track to the memory corresponding to each of the one or more user-defined touch zones.

Another aspect of the invention is directed to a method of associating an audio track to a user-defined touch zone of a photo supported by the frame. The method includes receiving a plurality of touch inputs, generally from a single touch gesture, through the photo placed over a capacitive sensor array, the plurality of touch inputs encircling a unique subset of capacitive sensors on the capacitive sensor array; generating, with a microprocessor in a recording mode and coupled to the capacitive sensor array, a user-defined touch zone based on a path covered by the touch gesture; and receiving an audio track corresponding to the user-defined touch zone for storage to a memory coupled to the microprocessor.

In some aspects of the disclosure, a photo frame includes a frame border having a presentation face, the presentation face having a plurality of capacitive sensors operable to detect touch inputs, and a masking material covering the plurality of capacitive sensors, wherein the masking material presents watermarks in front of each of the capacitive sensors, and wherein each capacitive sensor is operable to detect touch inputs through the masking material; a microphone operable to receive audio; a memory having a plurality of partitions, each partition configured to store an audio track received from the microphone and having a corresponding capacitive sensor from the plurality of capacitive sensors; a microprocessor configured to detect a touch input from one of the plurality of capacitive sensors and configured to activate the microphone for receiving the audio track for storage to the corresponding partition.

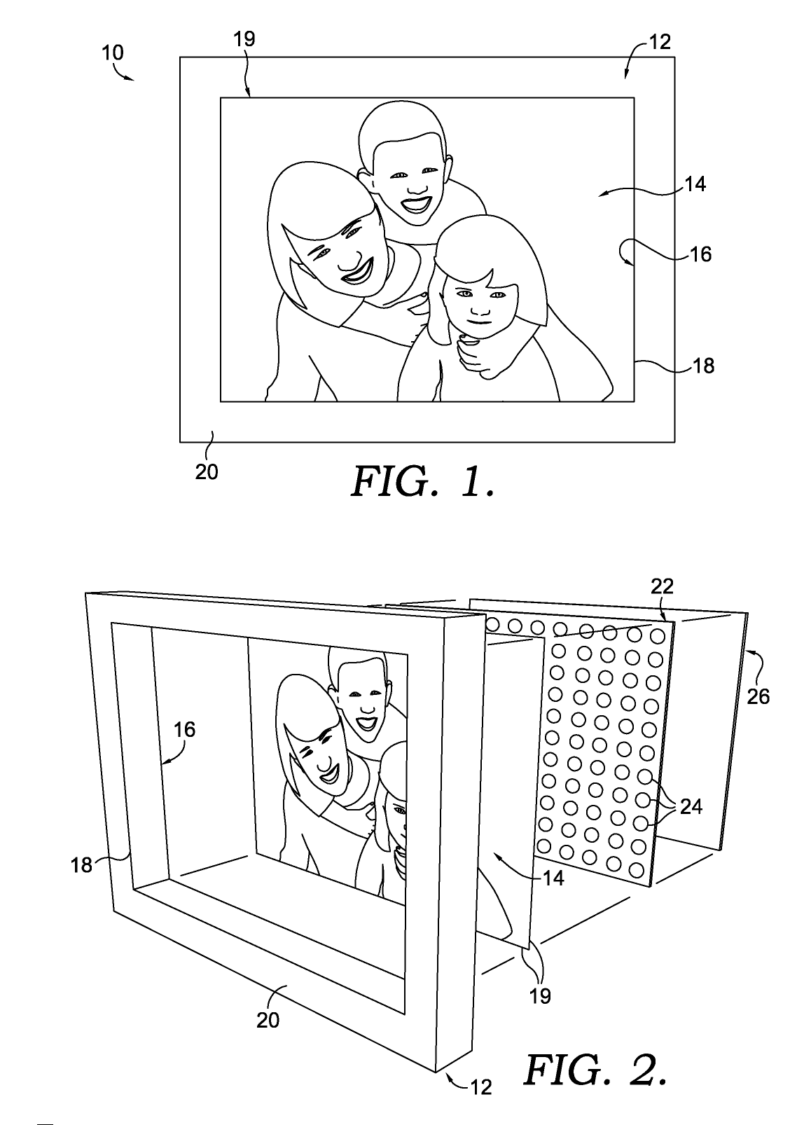

With reference now to the figures, methods and devices are described in accordance with embodiments of the invention. Various embodiments are described with respect to the figures in which like elements are depicted with like reference numerals. Referring initially to FIGS. 1-3, in one aspect of the invention, a photo frame assembly 10 is provided having a frame border 12 and an exemplary photo 14 secured therein. The frame border 12 presents a front-side opening 16 defined by a front-side inner circumference 18 of the frame border 12, such that the image captured in the exemplary photo 14 projects therethrough. In embodiments, the front-side frame opening 16 may be smaller than a sizing configuration 19 of the exemplary photo 14 to prevent disengagement of the photo 14 from the frame assembly 10, as will be discussed further herein. Although preferably smaller, the opening 16 can be substantially similar to a standardized size of the exemplary photo 14 (e.g., 4×6, 5×7, 8.5×11, 9×12, etc.). The frame border 12 also includes a presentation face 20 facing a same general direction as the frame opening 16.

The photo frame assembly 10 also includes a capacitive sensor array 22, as shown in FIG. 2. The capacitive sensor array 22 includes a plurality of capacitive sensors 24 operable to detect touch inputs. While the illustrated embodiment and the embodiment described herein is described as having capacitive sensors, it is within the scope of the present application to use other types of sensors instead of or in addition to capacitive sensors 24. The sensors merely need to detect touch inputs. The capacitive sensor array 22 is configured for placement behind the image projected by the exemplary photo 14, such that the photo 14 is positioned thereon and touch inputs are detected through the photo 14 by the sensor array 22. In some embodiments, a backing board 26 is provided for secured placement behind the sensor array 22, such that the sensor array 22 is interposed between the photo 14 and backing board 26. While the illustrated embodiments depict the capacitive sensor array 22 and backing board 26 as having substantially similar dimensions to the photo sizing configuration 19, it should be understood that sizing may vary while staying within the scope of the present invention. Further, it should be understood that the backing board 26 may be eliminated or interchanged with other materials without departing from the scope of the present invention.

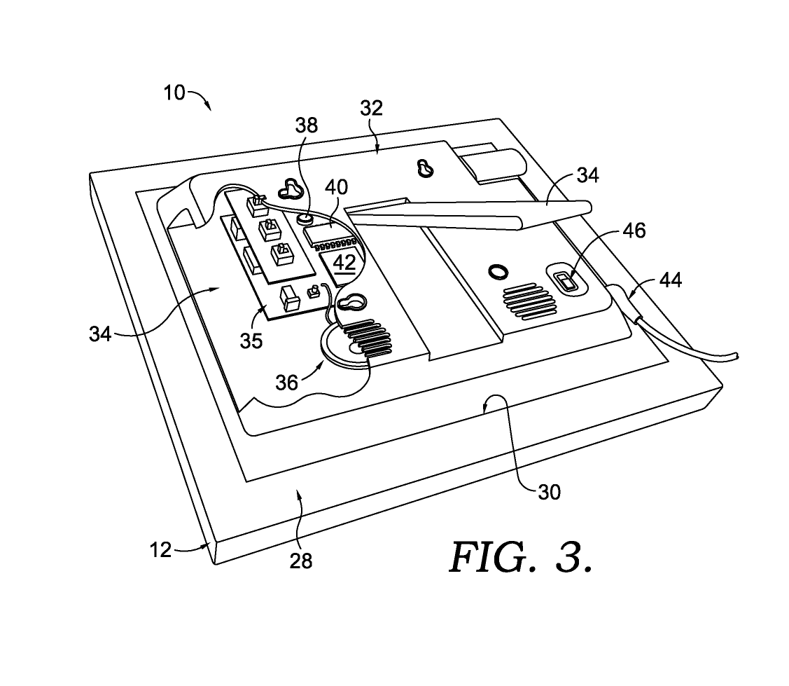

Referring now to FIG. 3, the frame border 12 presents a rear face 28 opposite the presentation face 20. The frame border 12 includes a rear-side frame opening 30 immediately adjacent the rear face 28, the rear-side opening 30 defined by a rear-side inner circumference of the frame border 12. In embodiments, a rear-side frame opening 30 can provide for removable engagement of a housing or enclosure 32 to the frame border 12. In some embodiments, the enclosure 32 may be integral with the backing board 26. The enclosure 32, in some embodiments, includes a kickstand 34 for propping the frame assembly 10 into an upright position, as can be appreciated by one skilled in the art. The enclosure 32 includes a chamber 34 for containing electrical components of the photo frame assembly 10. The chamber 34 houses a logic board 35 for directly or indirectly coupling components including a speaker 36, a microphone 38, a memory 40, and one or more processors or microprocessors 42. The components are coupled to a power source, such as the external power source 44 of FIG. 3, however, any power source (e.g., portable batteries) may be considered for use with the present invention. Although not shown, in some embodiments, the logic board 35 may also be coupled to a communications bus (such as a USB, Firewire, serial port, etc.) operable for transferring data (i.e., media files) between an external computer-readable media and the memory 40.

The frame assembly 10 may include a variety of computer-readable media. Computer-readable media can be any available media that can be accessed by the frame assembly 10 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the frame assembly 10. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 40 includes computer-storage media in the form of volatile and/or nonvolatile memory. The memory may be removable, non-removable, or a combination thereof. Exemplary hardware devices include solid-state memory, hard drives, optical-disc drives, etc. The frame assembly 10 includes one or more processors 42 that read data from various entities such as memory 40 or I/O components (not shown). The memory may be operable to store computer-readable instructions for execution by one or more processors. The memory may also be operable to store media (e.g., audio files, recordings, or audio “tracks”) including other data structures. In some embodiments, the data structures can be related to user-defined touch zones generated by one or more processors and corresponding to particular audio files, as will be described herein.

In some embodiments, the sensor array is operable to detect touch inputs on any one of the plurality of capacitive sensors 24 disposed thereon. Each capacitive sensor 24 is operable to detect a touch input (i.e., a finger touch), such that the capacitive sensor array 22 can detect, from a user, a plurality of touch inputs from a single touch gesture conducted across a plurality of capacitive sensors 24 (i.e., a finger swipe). The capacitive sensor array 22 is operable to detect a sequence of touch inputs from a single touch gesture across a plurality of capacitive sensors 24, and communicate the location of each touch corresponding to a capacitive sensor 24 and its position on the capacitive sensor array 22 to the one or more processors 42. In some embodiments, the capacitive sensor array 22 may be passive, such that the processor detects the touch inputs based on body capacitance sensed by the individual capacitive sensors 24 on the capacitive sensor array 22. The one or more processors 42 may be operable to receive, from the capacitive sensor array 22, a plurality of signals each corresponding to a touch input on a particular capacitive sensor 24 and a location thereof with respect to the capacitive sensor array 22.

In other embodiments, the processor 42 may include executable instructions embedded thereon, or may read executable instructions stored in the memory 40. As such, the processor may execute instructions for generating user-defined touch zones based on the detection of one or more touch inputs encircling any subset of capacitive sensors. In some embodiments, the generation of user-defined touch zones is performed sequentially, based on the order in which the touch inputs were detected. For example, a first touch gesture conducted on the capacitive sensor array 22 encircling a first group of capacitive sensors can initiate the generation of a first user-defined touch zone. In other words, the first group of capacitive sensors encircled by the first touch gesture path may include all capacitive sensors included in the gesture path as well as all capacitive sensors encircled thereby. As such, the first touch zone may include all capacitive sensors in the first group. In some embodiments, a second touch gesture conducted on the capacitive sensor array 22 may encircle a second group of capacitive sensors, initiating the generation of a second user-defined touch zone. As a result, the second touch zone may include all capacitive sensors in the second group. In some instances, the second touch gesture may overlap one or more capacitive sensors included in the first touch zone. In such an event, the second touch zone may take priority over the capacitive sensors and each of the overlapped capacitive sensors may be reassociated with the second touch zone. In some other instances, priority may be provided to the first touch zone, whereby overlapped capacitive sensors are not reassociated to the second touch zone.

In some embodiments, the processor's generation of a touch zone may initiate immediately or briefly thereafter, an audio recording session, by activating the microphone 38. In some instances, an audible feedback (e.g., a beep or voice instruction) is also provided through the speaker 36 to confirm generation of the touch zone to a user and/or instruct the user to provide an audio recording corresponding to the newly generated touch zone. The microphone 38 is operable to receive the user provided audio and record it to the memory 40 corresponding to the most recently generated touch zone. In some embodiments, the memory 40 is partitioned to receive a maximum number of touch zones and/or corresponding audio recordings. In other embodiments, the memory partitions may limit each audio recording to a maximum recording duration. In embodiments, the audio recording can timeout upon reaching the maximum recording duration and be stored into memory. The recording may be stored with reference data (e.g., metadata) corresponding to the most recently generated touch zone. In other embodiments, the user may intentionally stop the recording by inputting a stop command such as touching any one of the capacitive sensors encircled by the corresponding most recently generated touch zone. An audible confirmation may be provided to the user upon a storing of the audio track corresponding to the most recently generated touch zone (e.g., a playback of the audio recording or a beep).

In one embodiment, the processor 42 may be able to detect a user's selection of a user-defined touch zone from a plurality of generated user-defined touch zones. For example, after the user has generated several touch zones and stored audio tracks corresponding thereto, the processor may be able to detect a user's selection of one of the touch zones to initiate playback of the corresponding audio track of the selected touch zone. In some embodiments, the processor may need to be changed into a playback mode, so that touch inputs detected by the capacitive sensor array 22 and/or the processor 42 are not misinterpreted as touch zone defining inputs. In such embodiments, in order to enable user-defined touch zone generation and the storage of corresponding audio tracks, the processor may need to be toggled into a recording mode. In embodiments, toggling an external switch, such as switch module 46 of FIG. 3, may toggle between the playback or recording modes.

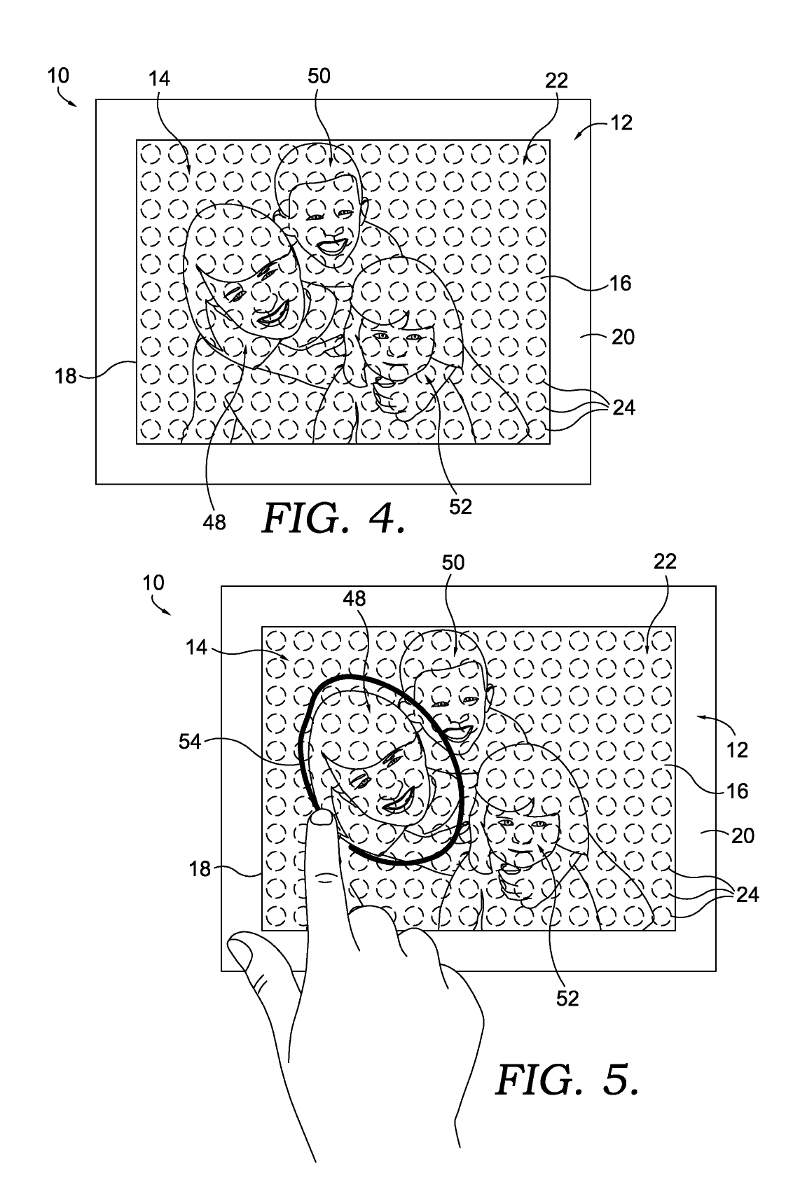

Turning now to FIG. 4, a photo frame (for instance, the frame assembly 10 of FIGS. 1-3) includes a capacitive sensor array 22 having an exemplary photo 14 overlaid thereon. As described above, the capacitive sensor array 22 may include a set of capacitive sensors arranged in a grid-like format. As illustrated in the exemplary photo 14, three separate and unique objects of interest are depicted: object one 48, object two 50, and object three 52 (i.e., the faces of a mother, her son, and her daughter, respectively). In embodiments, the photo frame must receive at least a first touch gesture from a user to initiate the creation of a first user-defined touch zone. The first touch gesture is detected using at least, for instance, the capacitive sensor array 22 of FIGS. 1-3. In some embodiments, the first touch gesture must be a first loop 54 encircling an object of the photo, such as object one 48 in FIG. 5.

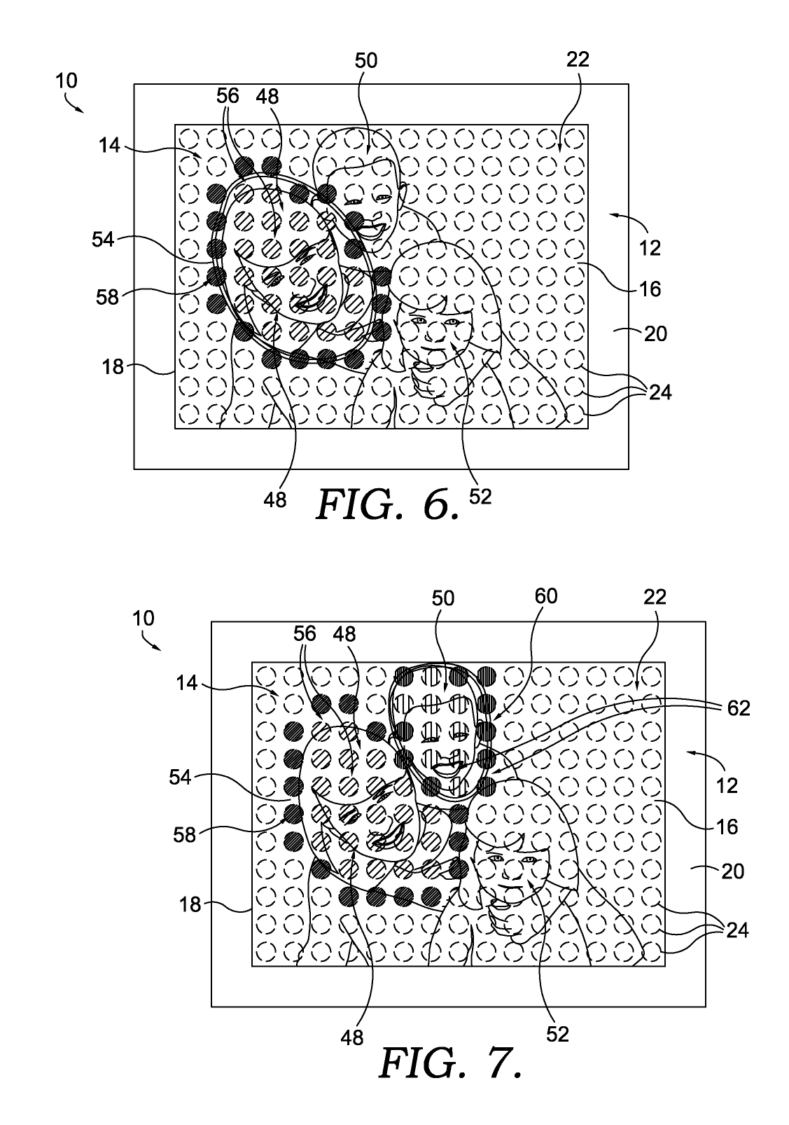

The first loop 54 of FIG. 5 may initiate the generation of a first user-defined touch zone based on the path covered by the touch gesture, defined by a first loop 54 drawn by the touch gesture. The first loop 54 includes each of the capacitive sensors 24 touched or activated by touch gesture, as indicated in FIG. 6 by the darker sensors 24. Enclosed within the first loop 54 is a first subset 56 of capacitive sensors 24, as indicated in FIG. 6 by the lighter upward diagonal cross-hatched sensors 24. The photo frame 10, using a processor coupled to the capacitive sensor array (for instance, the frame assembly 10 of FIGS. 1-3), may generate a first user-defined touch zone 58 including all capacitive sensors 24 in the first loop 54 and all capacitive sensors 24 included in the first subset 56.

In some embodiments, upon generation of the first user-defined touch zone 58, the photo frame produces an audible feedback alert to notify the user that the first user-defined touch zone 58 has been generated. Upon generation and notification of the first user-defined creation of a touch zone, the photo frame 10 initiates an audio receiving mode to receive a first audio track to correspond with the generated first user-defined touch zone 58. In the audio receiving mode, a microphone is enabled for receiving the first audio track. The first audio track is received by the microphone 38 included in the photo frame 10. The receipt of the first audio track may be terminated by either a time-out or a manual stop command input by the user. In some embodiments, a single touch input detected by at least one of the capacitive sensors 24 in the first user-defined touch zone 58 of capacitive sensors may terminate the recording mode and disable the microphone 38. In response to the detection of the stop command, the first audio track or an audible feedback alert can be played back to the user as confirmation that the first audio track was properly received by the photo frame 10. In other embodiments, once the first audio track is received, it is stored to the memory 40 along with a reference to the corresponding first user-defined touch zone 58.

Moving forward now to FIG. 7, a second user-defined touch zone 60 can be generated based on a second touch gesture forming a second loop (corresponding to the darker vertical crosshatching) encircling object two 50. An encircled second subset of capacitive sensors 24 is identified by the lighter vertical crosshatching. Collectively the darker and lighter vertical crosshatched capacitive sensors 62 define the second user-defined touch zone 60. As shown in the illustration, the capacitive sensors 62 of the second user-defined touch zone 60 may include at least some of the capacitive sensors 24 that were originally associated with first subset 56. In essence, the subsequent second user-defined touch zone 60 may have priority over any capacitive sensors 24 on the capacitive sensor array 22 based on the breadth of the second loop. Upon creation of the second user-defined touch zone 60, similar to the first audio track, a second audio track is received by the photo frame 10 and configured to correspond to the second user-defined touch zone 60.

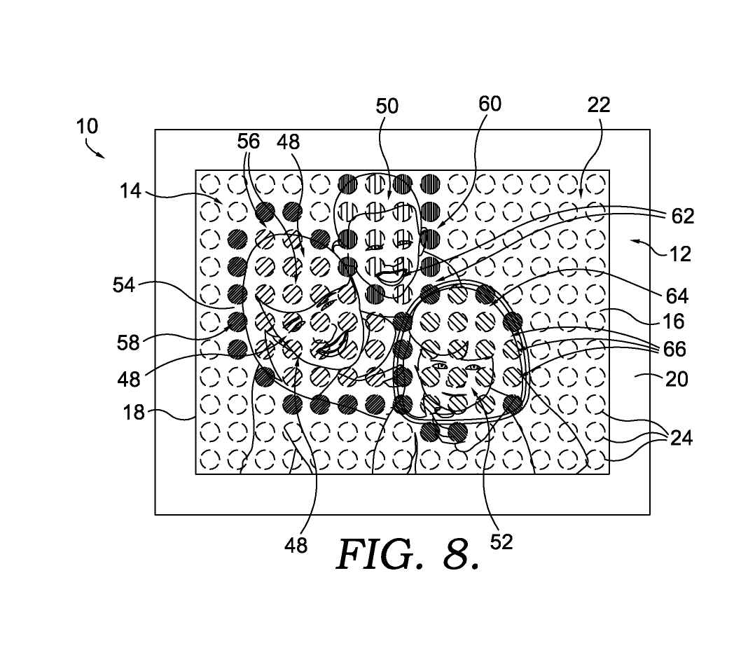

Looking now to FIG. 8, a third user-defined touch zone 64 can be generated based on a third touch gesture forming a third loop (corresponding to the darker downward diagonal crosshatching) encircling object three 52. An encircled third subset of capacitive sensors 24 is identified by the lighter downward diagonal crosshatching. Collectively the darker and lighter downward diagonal crosshatched capacitive sensors 66 define the third user-defined touch zone 64. As illustrated, the capacitive sensors 66 may include at least some of the capacitive sensors 24 originally associated with any combination of the first subset 56 and second subset 62. In essence, the subsequent third user-defined touch zone 64 may have priority over any capacitive sensors 24 on the capacitive sensor array 22 based on the breadth of the third loop. Upon creation of the third user-defined touch zone 64, a third audio track is received by the photo frame 10 and configured to correspond to the third user-defined touch zone 64.

It is within the scope of the invention to consider that zero, one, or more user-defined touch zones may be generated and associated with a corresponding audio track. Each touch zone and corresponding audio track can be subsequently stored using, for instance, the memory 40 of FIG. 3.

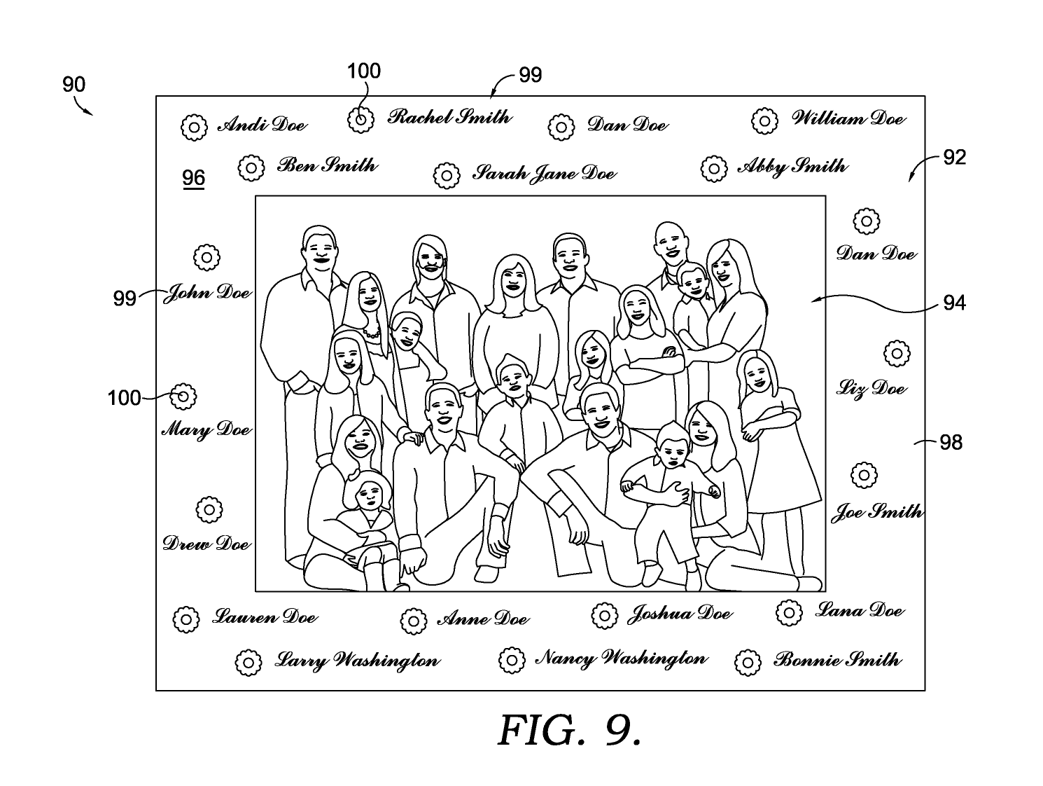

Turning now to FIG. 9, an alternative embodiment of the present invention is depicted. A photo frame 90 including a frame border 92 and exemplary photo 94 is provided. Rather than having a capacitive sensor array behind the photo, a plurality of capacitive sensors may be positioned in the photo frame 90. In that regard, the frame border 92 includes a presentation face 96 in the same general direction as the image projected by the exemplary photo 94. A plurality of capacitive sensors (not shown), may be positioned behind the presentation face 96, with each being operable to detect touch inputs. The presentation face 96 may be covered with a masking material 98 that covers the plurality of capacitive sensors. The capacitive sensors are operable for detecting touch inputs through the masking material 98. In some embodiments, the masking material 98 is comprised of a writeable material (e.g., paper, cloth, plastic) suitable for receiving names, signatures, handwritten messages and/or remarks 99. The masking material 98 may also include a plurality of watermarks or designs (e.g., circles, flowers, stars, etc.) 100 positioned to overly each of the capacitive sensors. The watermarks 100 are provided for presenting touch points on the frame border 92, so as to indicate to a user the locations of each capacitive sensor hidden thereunder.

Similar to the frame assembly 10 of FIGS. 1-3, the photo frame 90 also includes a microphone operable to receive audio, a memory, a speaker, and a processor configured to detect the duration of each touch input. The processor or memory may include executable instructions for determining a user's intent based on the duration of touch inputs for each capacitive sensor. For instance, the detection of a long input (i.e., longer than 2 seconds) from one of the plurality of capacitive sensors may trigger, through the processor, an activation of the microphone for receiving an audio track for storage to the memory. The audio track can be stored to the memory corresponding to the capacitive sensor that triggered the activation of the microphone. In some embodiments, the memory may be comprised of partitions, wherein each partition is configured to store an audio track received from the microphone and to correspond to the capacitive sensor that triggered the activation of the microphone and receipt of the audio track. This embodiment allows for the display of a group photo and provides the members of the photo to record their own messages associated with the photo. A user of the photo frame 90 may have each of the members of the photo sign or print their name 99 adjacent a watermark 100 on the presentation face 96 and record their own audio message. Subsequent viewers of the photo can press the various watermarks 100 to hear what each of the members of the photo had to say about the photo or the event to which the photo pertained (e.g., a graduation, birthday party, etc.). In an embodiment, the masking material 98 may be washable so that all of the writings thereon may be erasable should the owner of the photo frame 90 desire to later switch out the photo 94 for a new photo and have the new photo members record their own messages and sign their own names.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

1. A photo frame with user-definable touch zones, the photo frame comprising:
a frame body for supporting a photo;
a capacitive sensor array coupleable to the frame body and including a set of capacitive sensors, wherein each capacitive sensor in the set is operable to detect touch inputs;
a memory coupled with the frame body and operable for storing one or more user-defined touch zones, wherein each user-defined touch zone corresponds to a unique subset of capacitive sensors in the set of capacitive sensors;
a microprocessor coupled with the capacitive sensor array and the memory, wherein the microprocessor is configured to generate each of the one or more user-defined touch zones by detecting one or more touch inputs, and wherein the one or more touch inputs define the unique subset of capacitive sensors; and
a microphone coupled to the microprocessor and operable to record an audio track to the memory corresponding at least one of the one or more user-defined touch zones.

2. The photo frame of claim 1, wherein the microprocessor is configured to sequentially generate the one or more user-defined touch zones, and wherein each sequentially generated user-defined touch zone has priority to correspond to capacitive sensors already corresponding to previously-generated user-defined touch zones.

3. The photo frame of claim 1, wherein the microphone is configured to automatically begin recording of an audio track for each of the one or more user-defined touch zones briefly after detecting the defining of the unique subset of capacitive sensors from the one or more touch inputs.

4. The photo frame of claim 3, wherein recording of the audio track is terminated upon detection of a touch input within a user-defined touch zone.

5. The photo frame of claim 1, wherein the microprocessor is further configured to determine a selection of a touch zone from the one or more user-defined touch zones based on a touch input being detected therein.

6. The photo frame of claim 5, further comprising a speaker coupled to the microprocessor and operable to playback, from the memory, the audio track corresponding with the selected touch zone.

7. The photo frame of claim 6, further comprising:
a switch module coupled to the microprocessor and operable to toggle between at least a recording mode and a playback mode, wherein the recording mode permits touch input detection to generate user-defined touch zones, and wherein the playback mode permits touch input detection to select one of the user-defined touch zones for playback of an audio track associated with the user-defined touch zone where touch input was detected.

8. The photo frame of claim 1, wherein the one or more user-defined touch zones include both capacitive sensors touched during a touch input and capacitive sensors encircled by the capacitive sensors touched during the touch input, and wherein the microprocessor determines the capacitive sensors encircled the capacitive sensors touched during the touch input.

9. The photo frame of claim 1, wherein the capacitive sensor array is configured for having a photo overlaid thereon and operable to detect one or more touch inputs therethrough.

10. The photo frame of claim 1, wherein the memory is partitioned to include a predetermined maximum number of audio tracks each corresponding to a user-defined touch zone.

11. A method of defining a touch zone for a photo frame and associating an audio recording therewith, the method comprising:
receiving a touch gesture through a photo;
generating a user-defined touch zone based on a path covered by the touch gesture; and
receiving an audio track for correspondence to the user-defined touch zone.

12. The method of claim 11, wherein the touch gesture forms a closed loop around an object of the photo, and wherein the generating a user-defined touch zone includes selecting an area encircled by the closed loop and associating it with the user-defined touch zone.

13. The method of claim 11, wherein the receiving step further includes enabling a microphone for receiving the audio track, the receiving occurring automatically substantially upon the generation of the user-defined touch zone.

14. The method of claim 11, wherein the receiving of the audio track is terminated upon a detection of a stop command.

15. The method of claim 14, wherein the stop command is a touch input detected within the user-defined touch zone.

16. The method of claim 14, further comprising:
playing the audio track upon the detection of the stop command to confirm that the audio track was properly received.

17. The method of claim 11, wherein an audible feedback is produced upon the generation of the user-defined touch zone.

18. The method of claim 11, wherein the correspondence includes storing the audio track to a memory with a reference to the corresponding user-defined touch zone for subsequent playback.

19. The method of claim 18, wherein the subsequent playback is initiated upon a detecting of a touch input within the user-defined touch zone.

20. The method of claim 18, wherein the audio track is time-restricted based on the memory being partitioned to hold a maximum number of audio tracks.
